(19) United States
(12) Patent Application Publication
(10) Pub. No.: US 2022/0351092 A1
(43) Pub. Date: Nov. 3, 2022

(54) SPACE STAGING METHOD AND SPACE STAGING SYSTEM

(71) Applicant: Panasonic Intellectual Property Management Co., Ltd., Osaka (JP)

(72) Inventors: Yoshinori OKAZAKI, Osaka (JP); Takashi YAMADA, Osaka (JP); Yoshito TANAKA, Kyoto (JP); Hisao SASAI, Osaka (JP); Makoto KAWASAKI, Osaka (JP)

(21) Appl. No.: 17/751,932

(22) Filed: May 24, 2022

Related U.S. Application Data
(63) Continuation of application No. PCT/JP2020/043175, filed on Nov. 19, 2020.

(30) Foreign Application Priority Data
Nov. 26, 2019 (JP) 2019-213720

(51) Int. Cl. G06Q 10/02; G07C 9/00

(52) U.S. Cl. CPC G06Q 10/02; G07C 9/00

(57) ABSTRACT

A space staging method includes a reservation information acquisition step, an entry detection step, a determination step, and a staging execution step. The reservation information acquisition step is a step of acquiring reservation information about a reservation of a target space of a facility from a server. The entry detection step is a step of detecting whether a user specified by the reservation information has entered a specific space in the facility. The determination step is a step of determining a number of times of entry of the user into the specific space upon detection of entry of the user into the specific space in the entry detection step. The staging execution step is a step of causing a staging system generating a stimulus to at least one of five senses of human in the facility to execute staging processing.

### TECHNICAL FIELD

The present disclosure generally relates to a space staging method, a program, and a space staging system. The present disclosure particularly provides a space staging method, a program, and a space staging system that generate a stimulus to at least one of five senses of human in a facility.

### BACKGROUND ART

Conventionally, a technique of staging a space by emitting light into the space has been proposed (see, for example, PTL 1).

### CITATION LIST

### Patent Literature

PTL 1: Unexamined Japanese Patent Publication No. 2019-067764

### SUMMARY

An object is to provide a space staging method, a program, and a space staging system capable of executing space staging suitable for a user at an appropriate timing in a facility.

A space staging method according to one aspect of the present disclosure includes a reservation information acquisition step, an entry detection step, a determination step, and a staging execution step. The reservation information acquisition step is a step of acquiring reservation information about a reservation of a target space of a facility from a server. The entry detection step is a step of detecting whether a user specified by the reservation information has entered a specific space in the facility. The determination step is a step of determining a number of times of entry of the user into the specific space upon detection of entry of the user into the specific space in the entry detection step. The staging execution step is a step of causing a staging system generating a stimulus to at least one of five senses of human in the facility to execute staging processing. The staging processing includes first staging processing based on the number of times determined in the determination step and second staging processing based on the control content determined by the reservation information.

A program according to one aspect of the present disclosure is a program that causes at least one processor to execute the space staging method.

A space staging system according to one aspect of the present disclosure includes a reservation information acquirer and a staging executor. The reservation information acquirer acquires reservation information about a reservation of a target space of a facility from a server. Upon detection of entry of the user specified by the reservation information into the specific space in the facility, the staging executor causes the staging system that generates a stimulus to at least one of five senses of human in the facility to execute staging processing. The staging processing includes first staging processing based on the number of times of entry of the user into the specific space and second staging processing based on a control content determined by the reservation information.

The aspect of the present disclosure has an advantage that space staging suitable for the user can be executed at an appropriate timing in the facility.

### BRIEF DESCRIPTION OF THE DRAWINGS

FIG. 1 is a schematic explanatory view of a facility to which a space staging method according to one exemplary embodiment is applied.

FIG. 2 is a flowchart of a service provided to a user in relation to the facility.

FIG. 3 is an explanatory view of an example of a guest room of the facility.

FIG. 4 is an explanatory view of a first example of space staging in the facility.

FIG. 5 is an explanatory view of a second example of space staging in the facility.

FIG. 6 is a flowchart of the space staging method.

FIG. 7 is a block diagram of a facility system that implements the space staging method.

FIG. 8 is a block diagram of a terminal device included in the facility system.

FIG. 9 is a block diagram of a management system included in the facility system.

FIG. 10 is a block diagram of a space staging system included in the facility system.

FIG. 11 is a block diagram of a control system that implements the space staging system.

FIG. 12 is a flowchart of operation (change operation) of the space staging system.

FIG. 13 is a flowchart of operation (adjustment operation) of the space staging system.

FIG. 14 is an explanatory view of a third example of space staging in the facility.

FIG. 15 is an explanatory view of a fourth example of space staging in the facility.

FIG. 16 is an explanatory view of a fifth example of space staging in the facility.

FIG. 17 is an explanatory view of a sixth example of space staging in the facility.

FIG. 18 is an explanatory view of another example of space staging in the facility.

FIG. 19 is a flowchart of a space staging method according to a second modification.

### DESCRIPTION OF EMBODIMENT

(1) Exemplary embodiment

(1-1) Outline

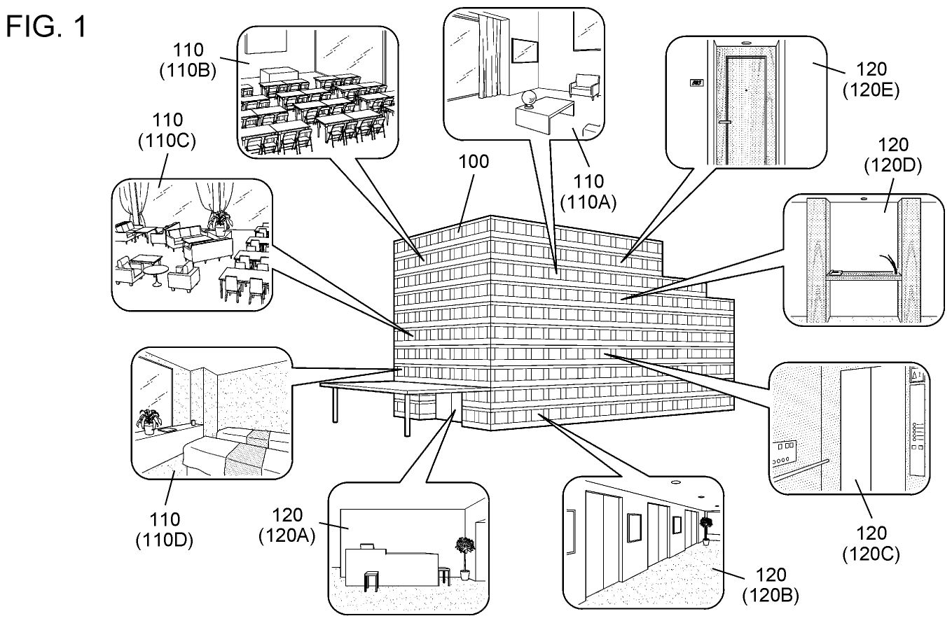

A space staging method according to one exemplary embodiment can be used to generate a stimulus to at least one of the five senses of human in facility 100 as illustrated in FIG. 1. In the exemplary embodiment, facility 100 is assumed to be a hotel which is a type of accommodation facility, particularly, a resort hotel. Hereinafter, facility 100 may be referred to as hotel 100 for easy understanding of the description. As shown in FIG. 1, hotel 100 provides various spaces for user use. Here, in the exemplary embodiment, a space that can be a target of reservation by a user is referred to as target space 110, and a space that cannot be a target of reservation by a user is referred to as non-target space 120.

A reservation can be an action of designating date and time to visit and securing the user's right to use the space. Examples of the reservation include an accommodation reservation and a use reservation. The reservation may be an action of allocating a specific space from a plurality of spaces to the user in a check-in counter of hotel 100. If the user specifies a type of guest room of hotel 100 and a staff member assigns an actual guest room, the reservation may be actions from the specification by the user to the assignment by the staff member. The reservation may be an action in which a staff member determines a specific seat from a plurality of seats and assigns the seat to the user when the user enters a restaurant. If the user specifies a number of sears of the restaurant desired to be secured and the staff member assigns actual seats, the reservation may be actions from the specification by the user to the assignment by the staff member.

Examples of target space 110 include guest room 110A, conference room 110B, restaurant 110C, and recreational room 110D. Non-target space 120 includes front desk (including a reception, check-in counter, check-out counter, and the like) 120A, elevator hall 120B, elevator 120C, and guest room passages 120D, 120E. Note that facility 100 may include not only at least one building but also a building and a site on which the building exists. Examples of facility 100 include a house (for example, a single-family house or an apartment house) and a non-house (for example, a factory, a park, a hospital, a commercial facility, an accommodation facility, an amusement facility, an office, or a building). Amusement facilities can include athletic facilities (playground, swimming area, skating rink, and the like) and concert halls. Facility 100 may be an integrated resort facility which is a complex facility gathering a casino, a hotel, a theater, a facility for meeting, incentive tour, convention, and exhibition (MICE facility) such as an international conference hall or an exhibition hall, a shopping mall, and the like.

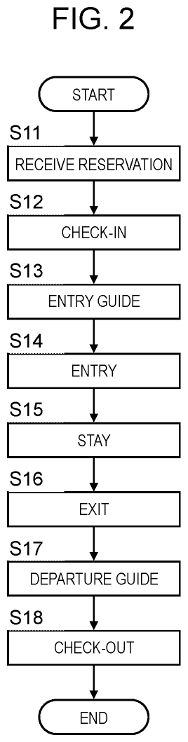

FIG. 2 illustrates a flow of services provided by an operator (operating company) of hotel 100 to users of hotel 100 in the exemplary embodiment. First, in a case where a user wishes to use hotel 100, the user makes a reservation. Hotel 100 receives a reservation from the user (S11). Here, it is assumed that the user stays at hotel 100, and the reservation of the user is an accommodation reservation. In this case, information necessary for the reservation is given from the user to hotel 100. The information necessary for the reservation can include personal information such as a date of staying, room information (type, grade, and the like), a number of guests staying, and name of the guests. Note that the accommodation reservation may be made by direct exchange between the user and hotel 100, or may be made via a travel agency, an agent for accommodation reservation, or the like. Then, hotel 100 performs a check-in procedure for the user who has visited hotel 100 at front desk 120A (S12). This procedure can determine the room to be used by the user. Thereafter, hotel 100 guides the user to guest room 110A through elevator hall 120B, elevator 120C, and guest room passages 120D, 120E (S13). When the user enters guest room 110A, hotel 100 gives explanation of guest room 110A and the like (S14). Then, hotel 100 provides various services while the user is staying in hotel 100 (S15). Examples of the services include services in guest room 110A (bed making, room service, and the like), services in conference room 110B, a service in restaurant 110C, and services in recreational room 110D (various activities such as spas). In the exemplary embodiment, on the final day of the stay of the user, hotel 100 provides the user with guidance regarding leaving in guest room 110A (S16). Hotel 100 guides the user to front desk 120A through elevator hall 120B, elevator 120C, and guest room passages 120D, 120E (S17). Then, hotel 100 performs a check-out procedure for the user at front desk 120A (S18). In this procedure, the use of hotel 100 by the user ends.

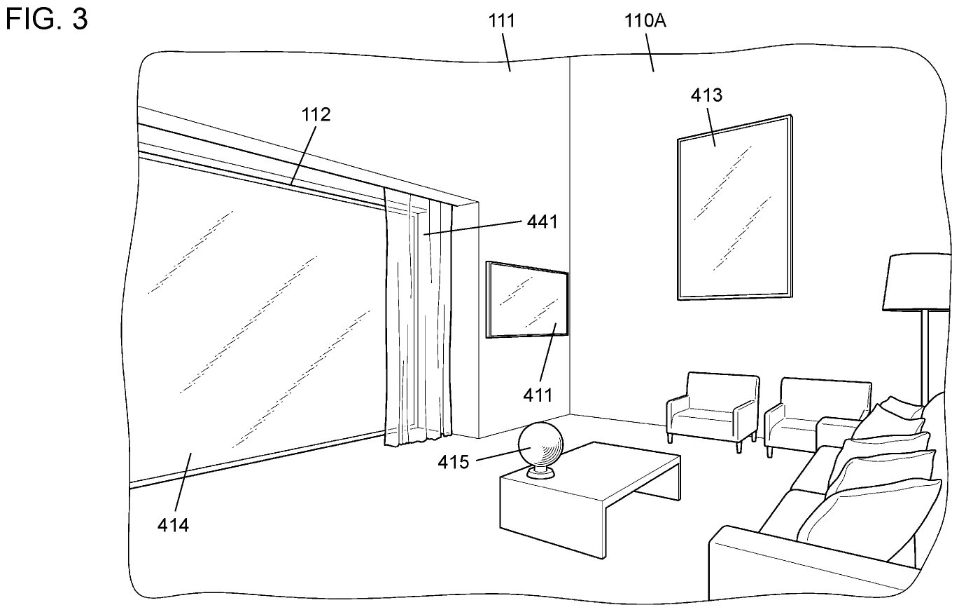

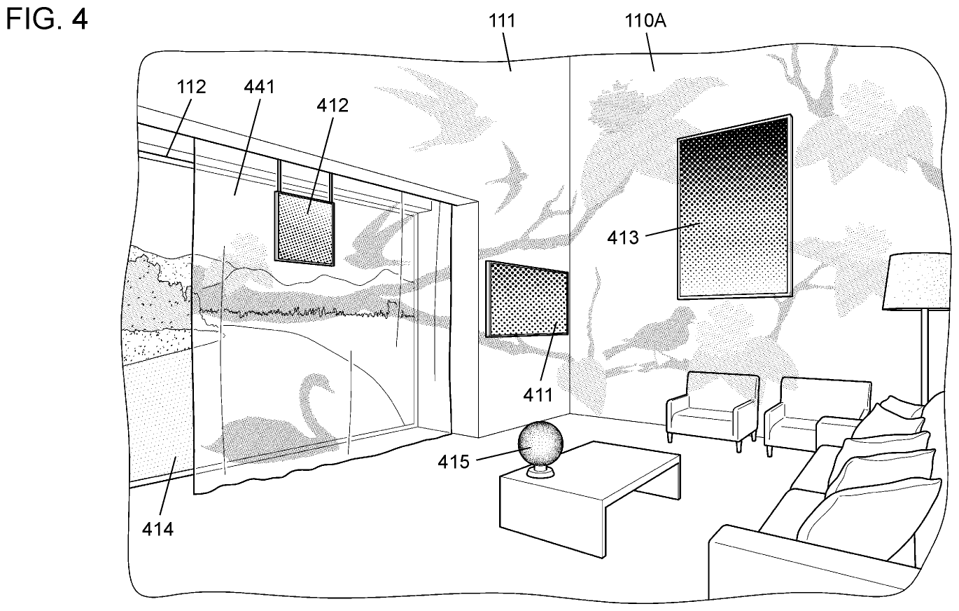

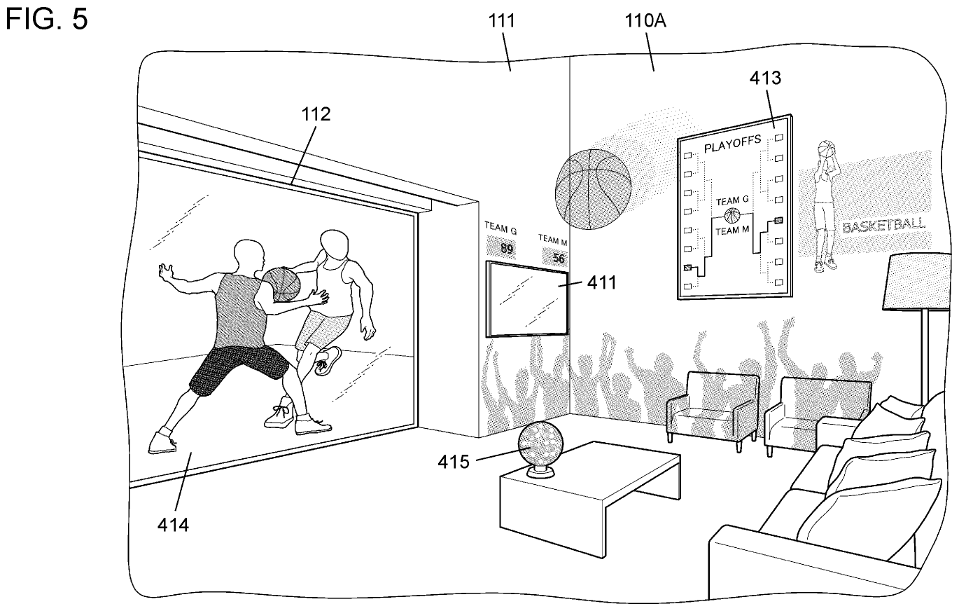

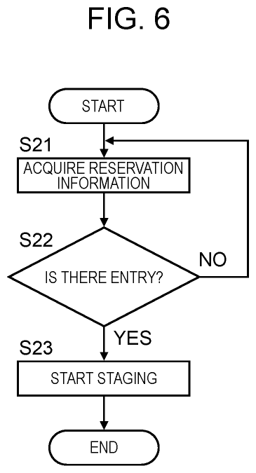

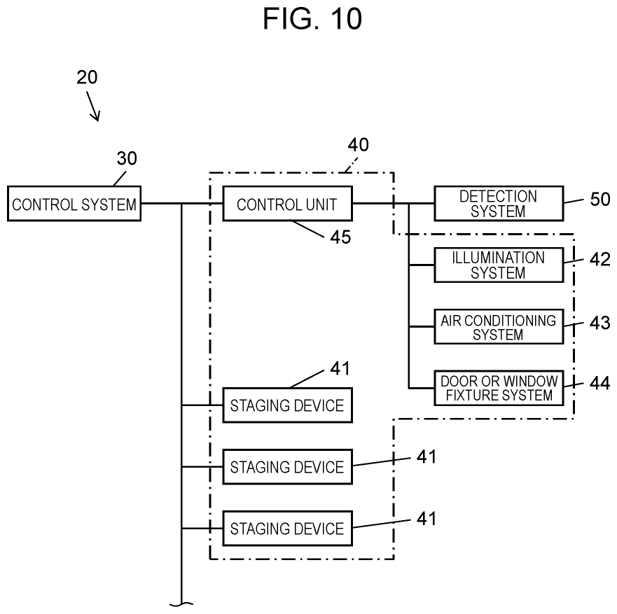

The space staging method according to the exemplary embodiment can be executed in such a series of services provided by hotel 100 to the user. For example, the space staging method according to the exemplary embodiment can be used for space staging in guest room 110A as illustrated in FIGS. 3 to 5. In guest room 110A, staging system 40 (see FIG. 10) is installed. Staging system 40 is a system for generating a stimulus to at least one of the five senses of human. Here, FIGS. 3 to 5 all illustrate same guest room 110A. However, FIG. 3 illustrates guest room 110A in which space staging by staging system 40 is not performed. FIGS. 4 and 5 illustrate guest room 110A in which space staging by staging system 40 is performed. In FIGS. 4 and 5, contents of the space staging by staging system 40 are different from each other. For example, in FIG. 4, space staging with a theme of nature is performed, and in FIG. 5, space staging of sports is performed. As described above, in guest room 110A, different space staging can be performed by staging system 40. The space staging method according to the exemplary embodiment is a method of causing staging system 40 to perform space staging. As illustrated in FIG. 6, the space staging method according to the exemplary embodiment includes reservation information acquisition step S21, entry detection step S22, and staging execution step S23. Reservation information acquisition step S21 is a step of acquiring reservation information about the reservation of target space (guest room) 110A of facility (hotel) 100. Entry detection step S22 is a step of detecting entry of the user specified by the reservation information into specific space (guest room) 110A in facility (hotel) 100. Staging execution step S23 is a step of causing staging system 40 generating a stimulus to at least one of the five senses of human in facility (hotel) 100 to execute staging processing based on a control content determined by the reservation information.

In the space staging method according to the exemplary embodiment, staging system 40 executes staging processing (see FIGS. 4 and 5) with entry of the user into specific space (guest room) 110A as a trigger. Thus, space staging can be executed at an appropriate timing in facility (hotel) 100. Then, the staging processing is based on the control content determined by the reservation information of the user, and it is possible to perform space staging suitable for a preference of the user, that is, space staging suitable for the user. For example, for a user who likes nature, space staging using nature as a theme as illustrated in FIG. 4 can be performed. For a user who likes sports, space staging using sports as a theme as illustrated in FIG. 5 can be performed. As described above, in the space staging method according to the exemplary embodiment, space staging suitable for the user can be executed at an appropriate timing in facility (hotel) 100. Thus, the user can experience different space staging each time in same target space (guest room) 110A. Therefore, a value of facility 100 can be increased in terms of the content that the user can experience in the facility.

(1-2) Details

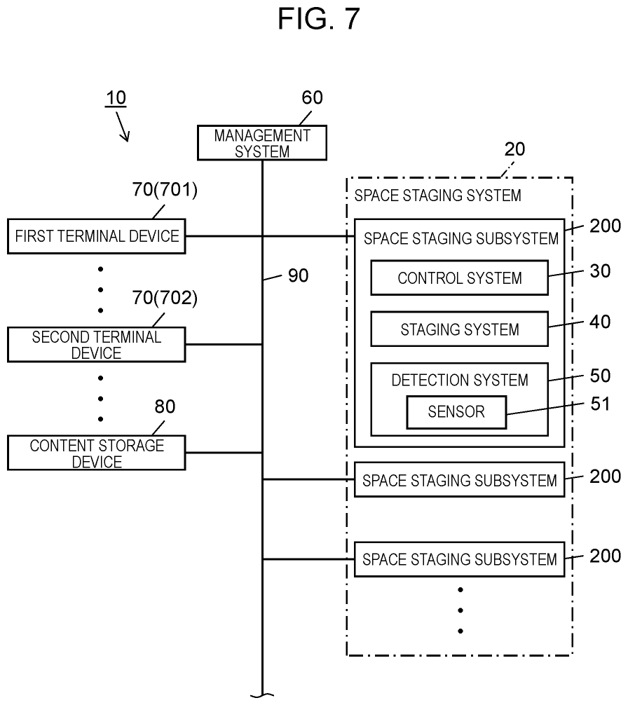

Hereinafter, the space staging method according to the exemplary embodiment will be described in more detail with reference to FIGS. 7 to 13. The space staging method according to the exemplary embodiment can be executed by space staging system 20 illustrated in FIG. 7.

Space staging system 20 can be connected to management system 60, terminal device 70 (first terminal device 701 and second terminal device 702), and content storage device 80 via communication network 90. Space staging system 20 constitutes facility operation system 10 together with management system 60, terminal device 70, and content storage device 80. In other words, facility operation system 10 includes space staging system 20, management system 60, terminal device 70, and content storage device 80.

Communication network 90 can include the Internet. Communication network 90 can include not only a network conforming to a single communication protocol but also a plurality of networks conforming to different communication protocols. The communication protocol can be selected from a variety of well-known wired and wireless communication standards. Although simplified in FIG. 7, communication network 90 can include a data communication device such as a repeater hub, a switching hub, a bridge, a gateway, a router, and the like.

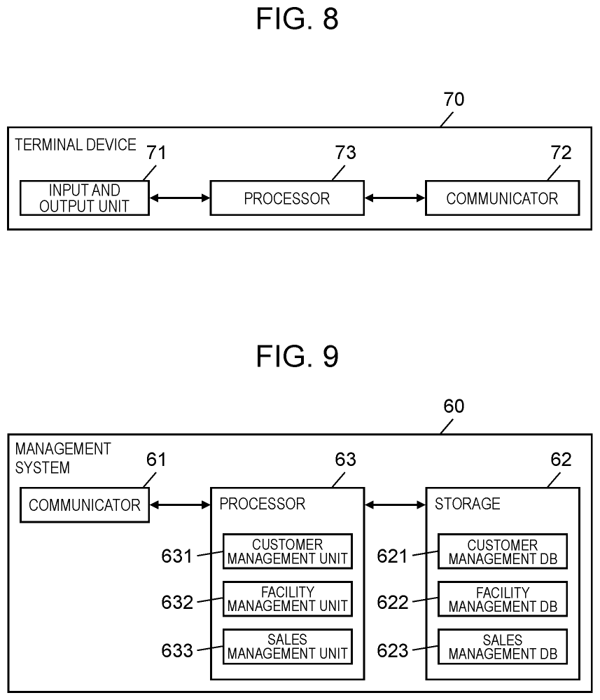

Terminal device 70 is used to input information to space staging system 20 and management system 60 and to display information from space staging system 20 and management system 60. As illustrated in FIG. 8, terminal device 70 includes input and output unit 71, communicator 72, and processor 73. Terminal device 70 can be implemented by a desktop computer, a laptop computer, or a mobile terminal (smartphone, tablet terminal, wearable terminal, or the like).

Input and output unit 71 includes an input device for operating terminal device 70. The input device can include, for example, a keyboard, a mouse, a trackball, a touch pad, a microphone for acquiring sound, an imaging device (such as a camera), and the like. The imaging device can be used to acquire an image of a gesture or a two-dimensional code of the user. Input and output unit 71 includes an image display device for displaying information. The image display device can include a thin display device such as a liquid crystal display or an organic EL display.

Communicator 72 is a communication interface. Communicator 72 is connectable to communication network 90, and has a function of performing communication through communication network 90. Communicator 72 includes, for example, a transmitter and a receiver. Communicator 72 conforms to a predetermined communication protocol. The predetermined communication protocol can be selected from a variety of well-known wired and wireless communication standards.

Processor 73 is configured to control overall control of terminal device 70, that is, control input and output unit 71 and communicator 72. Processor 73 has a function of transmitting information input in accordance with an operation of input and output unit 71 from communicator 72 to space staging system 20 or management system 60 through communication network 90. Processor 73 has a function of presenting, by input and output unit 71, information from space staging system 20 or management system 60 received by communicator 72 through communication network 90. Processor 73 can be implemented by, for example, a computer system including at least one processor (microprocessor) and at least one memory.

Here, first terminal device 701 is assumed to be used by the user. That is, first terminal device 701 can be used as an interface for providing the user with access to facility operation system 10. For example, the user can make various requests such as reservation of target space 110 to hotel 100 using first terminal device 701, and can obtain a response from hotel 100 to the request. Note that first terminal device 701 may be a necessary object of the user or a necessary object (equipment) of hotel 100. For example, first terminal device 701 may be disposed in guest room 110A of hotel 100 for the user to freely use first terminal device 701.

Here, second terminal device 702 is assumed to be used by the staff member of hotel 100. That is, second terminal device 702 can be used as an interface for providing the staff member of hotel 100 with access to facility operation system 10. For example, the staff member can input information necessary for facility operation system 10 using second terminal device 702. In a case where second terminal device 702 is associated with restaurant 110C, information about sales and the like can be input. The staff member can respond to various requests from the user to hotel 100 such as reservation of target space 110. For example, in a case where receipt of the reservation of target space 110 from the user is accepted, the reservation information about the reservation of target space 110 of hotel 100 can be generated by second terminal device 702 and transmitted to management system 60.

Management system 60 is a system for intensively handling data for operation of facility (hotel) 100. Management system 60 can be mainly used for customer management, management of facility 100, sales management, and the like. As illustrated in FIG. 9, management system 60 includes communicator 61, storage 62, and processor 63. Management system 60 can be implemented by a server.

Communicator 61 is a communication interface. Communicator 61 is connectable to communication network 90, and has a function of performing communication through communication network 90. Communicator 61 includes, for example, a transmitter and a receiver. Communicator 61 conforms to a predetermined communication protocol. The predetermined communication protocol can be selected from a variety of well-known wired and wireless communication standards.

Storage 62 is used to store information to be used by processor 63. For example, storage 62 stores customer management database 621, facility management database 622, and sales management database 623. In FIG. 9, for the purpose of simplification of illustration, the “database” is denoted as “DB”. Customer management database 621, facility management database 622, and sales management database 623 will be described later. Storage 62 includes at least one storage device. Examples of the storage device are a random access memory (RAM) and an electrically erasable programmable read only memory (EEPROM).

Processor 63 is a control circuit that controls operation of management system 60. Processor 63 can be implemented by, for example, a computer system including at least one processor (microprocessor) and at least one memory.

As illustrated in FIG. 9, processor 63 includes customer management unit 631, facility management unit 632, and sales management unit 633. In FIG. 9, customer management unit 631, facility management unit 632, and sales management unit 633 are not tangible components, but are functions implemented by processor 63.

Customer management unit 631 manages information about customers (users) of hotel 100. For example, customer management unit 631 registers customer information in customer management database 621. The information about the customer (user) can include identification information of the customer (user), attribute information of the customer (user), use information (use history and reservation history) of the customer (user), and the like. For example, customer management unit 631 can receive the reservation information about the reservation of target space 110 of hotel 100 from second terminal device 702 and generate the information about the customer on the basis of the reservation information. Facility management unit 632 manages information about target space 110 of hotel 100. For example, facility management unit 632 registers the information about target space 110 in facility management database 622. The information about target space 110 may include a reservation status, a use status, and the like of target space 110. Sales management unit 633 manages sales information of hotel 100. For example, sales management unit 633 registers sales information in sales management database 623. The sales information can include a use fee of target space 110 and the like. For example, sales management unit 633 can acquire sales or the like related to corresponding target space 110 from second terminal device 702.

Content storage device 80 can be used to store a control content used in space staging system 20. Details of the control content will be described later. For example, content storage device 80 stores a content database that registers a plurality of control contents. By updating the content database, the content of the space staging provided by space staging system 20 is also updated. Content storage device 80 can be implemented by a server.

Space staging system 20 is a system for generating a stimulus to at least one of the five senses of human in facility (hotel) 100. In particular, space staging system 20 is a system for generating a stimulus to at least one of visual, auditory, or tactile sense of human in facility (hotel) 100. In the exemplary embodiment, space staging system 20 includes a plurality of space staging subsystems 200 as illustrated in FIG. 7. For example, each of the plurality of space staging subsystems 200 can be installed in the space (target space 110, non-target space 120) of hotel 100. That is, in hotel 100, space staging can be performed for each space.

As illustrated in FIGS. 7 and 10, each space staging subsystem 200 includes control system 30, staging system 40, and detection system 50.

Staging system 40 is used to generate a stimulus to at least one of the five senses of human (in particular, visual, auditory, or tactile sense) in the corresponding space (target space 110, non-target space 120) in hotel 100. In the exemplary embodiment, staging system 40 can include at least one staging device 41. Staging device 41 can be a staging device that generates a stimulus to at least one of visual sense or auditory sense. Examples of the staging device (visual staging device) that generates a stimulus to visual sense include a display (signage display or wall display), an image display device (visual staging device) such as a projector, and a light source device that illuminates with special light such as a laser. For example, examples of the staging device (auditory staging device) that generates a stimulus to auditory sense include a sound output device (auditory staging device) such as a speaker.

Various systems are introduced into the space of hotel 100 (target space 110, non-target space 120), and these various systems can also be used as staging devices. In the exemplary embodiment, illumination system 42, air conditioning system 43, door or window fixture system 44, and control unit 45 are also included as staging devices in staging system 40. Illumination system 42 can include at least one illumination tool disposed in the space. Examples of the illumination tool include a ceiling light, a downlight, a spotlight, and a room light. Illumination system 42 can be mainly used for adjusting brightness of the space by illumination. Air conditioning system 43 can include at least one air conditioning device disposed in the space. Examples of the air conditioning device include an air conditioner, a fan, and a heater. Air conditioning system 43 can be mainly used for adjusting at least one of temperature or humidity of the space. Door or window fixture system 44 can include at least one air door or window fixture device disposed in the space. Examples of the door or window fixture device include an electric curtain, an electric shutter, and an electric window. Door or window fixture system 44 can be mainly used for adjusting brightness of the space by external light. Control unit 45 is a device for controlling illumination system 42, air conditioning system 43, and door or window fixture system 44. For example, control unit 45 transmits control signals to illumination system 42, air conditioning system 43, and door or window fixture system 44 to cause illumination system 42, air conditioning system 43, and door or window fixture system 44 to executed desired operations.

Detection system 50 is used to detect a person in the corresponding space (target space 110, non-target space 120) in hotel 100. Detection system 50 can include at least one sensor or the like. Detection system 50 includes, for example, sensor 51. Examples of sensor 51 include a human sensor such as a motion sensor and a current sensor. The human sensor can directly detect a human. Examples of the human sensor include an infrared sensor. Ultrasonic waves and visible light may be used for the human sensor. The current sensor can detect a person on the basis of a use state of the device or the like. A detection result of detection system 50 is given to control unit 45.

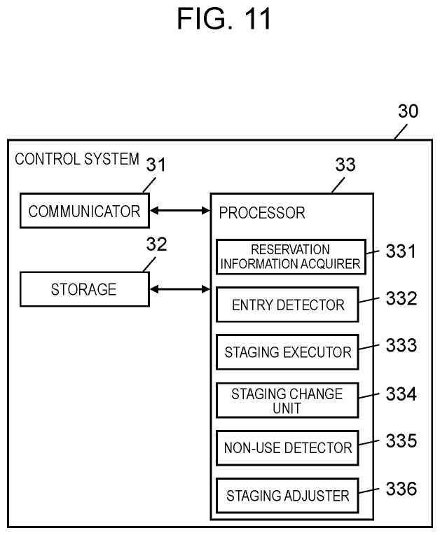

As illustrated in FIG. 11, control system 30 includes communicator 31, storage 32, and processor 33.

Communicator 31 is a communication interface. Communicator 31 is connectable to communication network 90, and has a function of performing communication through communication network 90. Communicator 31 includes, for example, a transmitter and a receiver. Communicator 31 conforms to a predetermined communication protocol. The predetermined communication protocol can be selected from a variety of well-known wired and wireless communication standards.

Storage 32 is used to store information to be used by processor 33. For example, storage 32 can be used to store a control content used in staging system 40. For example, a necessary control content can be acquired from content storage device 80 on the basis of the reservation information and stored in storage 32. The control content is information that defines the content of space staging by staging system 40. The content of the space staging by staging system 40 is the operation of staging devices (41 to 45) of staging system 40. Thus, the control content defines the operation (operation content and operation timing) of staging devices (41 to 45) of staging system 40. Storage 32 includes at least one storage device. Examples of the storage device are the RAM and the EEPROM.

Processor 33 is a control circuit that controls operation of control system 30. Processor 33 can be implemented by, for example, a computer system including at least one processor (microprocessor) and at least one memory. That is, at least one processor executes at least one (computer) program (application) stored in at least one memory to function as processor 33. In this example, the program is recorded in advance in the memory of processor 33. Alternatively, the program may be provided via a telecommunication line such as the Internet or by being recorded in a non-transitory recording medium such as a memory card.

As illustrated in FIG. 11, processor 33 includes reservation information acquirer 331, entry detector 332, staging executor 333, staging change unit 334, non-use detector 335, and staging adjuster 336. In FIG. 11, reservation information acquirer 331, entry detector 332, staging executor 333, staging change unit 334, non-use detector 335, and staging adjuster 336 are not tangible components, but are functions implemented by processor 33.

Reservation information acquirer 331 acquires the reservation information about the reservation of target space 110 of facility (hotel) 100. Reservation information acquirer 331 performs a step of acquiring the reservation information about the reservation of target space (guest room) 110A of facility (hotel) 100 (reservation information acquisition step S21). The reservation information can include information about a user who uses target space 110 (identification information and attribute information) and information about a period of use of target space 110. Further, in the exemplary embodiment, the reservation information includes staging information that specifies the control content of staging system 40. The staging information is determined by the user, for example, at time of reservation of target space 110 of facility (hotel) 100. The staging information is, for example, information about a theme of the space staging of target space 110. Examples of the theme include nature, sports, deep sea, space, and night scene. In the exemplary embodiment, reservation information acquirer 331 can acquire the reservation information from management system 60. That is, reservation information acquirer 331 can acquire the reservation information from management system 60 as a server. Reservation information acquirer 331 may acquire the reservation information at an arbitrary timing. In the exemplary embodiment, reservation information acquirer 331 acquires the reservation information after completion of a procedure of use of the target space in the facility by the user specified by the reservation information. For example, in a case where target space 110 is guest room 110A, the grade and the like of guest room 110A may be determined but a room number may not be determined at the time of the reservation of hotel 100. The room number of guest room 110A is often determined at time of check-in at front desk 120A (S12). Therefore, management system 60 may include the room number of guest room 110A in the reservation information and provide reservation information acquirer 331 with the room number of guest room 110A when the room is confirmed.

Entry detector 332 detects entry of the user specified by the reservation information into the specific space (guest room) in facility (hotel) 100. That is, entry detector 332 performs a step of detecting entry of the user specified by the reservation information into the specific space in facility (hotel) 100 (entry detection step S22). Specifically, entry detector 332 determined whether the user specified by the reservation information enters the specific space in facility (hotel) 100. Note that entry detector 332 may determine that the user enters the specific space not only when the user enters the specific space but also when the user takes an action of entering the specific space. For example, when the user is moving toward the specific space in a space connected to the specific space, entry detector 332 may determine that the user enters the specific space. That is, the determination of entry can have a temporal allowance, which can adjust a timing at which staging by staging system 40 starts and a timing at which the user enters the specific space. Detection system 50 can be used to detect entry of the user into the specific space in facility (hotel) 100. In the exemplary embodiment, control system 30 of each space staging subsystem 200 receives the detection result from detection system 50 of the plurality of space staging subsystems 200 of space staging system 20. Entry detector 332 of control system 30 detects entry of the user specified by the reservation information into the specific space in facility (hotel) 100 on the basis of the received detection result. The specific space can be any of spaces in hotel 100 (target space 110, non-target space 120). That is, the specific space may be target space 110 reserved by the user, or may be a space other than target space 110 reserved by the user (for example, non-target space 120).

Staging executor 333 causes staging system 40 generating a stimulus to at least one of the five senses of human in facility (hotel) 100 to execute staging processing based on the control content determined by the reservation information. That is, staging executor 333 performs a step of causing staging system 40 generating a stimulus to at least one of the five senses of human in facility (hotel) 100 to execute staging processing based on the control content determined by the reservation information (staging execution step S23). In the exemplary embodiment, the reservation information includes staging information that specifies the control content. For target space 110 reserved by the user, staging executor 333 determines the control content by using the staging information included in the reservation information. In the exemplary embodiment, staging executor 333 extracts staging information from the reservation information acquired by reservation information acquirer 331, and specifies the control content on the basis of the staging information. For example, staging executor 333 selects a control content from the plurality of control contents stored in content storage device 80 (the plurality of control contents prepared in advance) on the basis of the staging information included in the reservation information, and stores the selected control content in storage 32. When entry detector 332 detects entry of the user into the specific space, staging executor 333 causes staging system 40 to execute staging processing based on the selected control content. As a result, the space staging is performed. When the control content is changed, staging executor 333 causes staging system 40 to execute staging processing based on the changed control content. The control content is changed by staging change unit 334.

Staging system 40 is also installed in a space other than target space 110 and non-target space 120. Space staging for the user can also be performed in non-target space 120.

For example, in a route from front desk 120A of hotel 100 to target space 110 reserved by the user, staging processing of guiding the user to target space 110 can be performed. In this case, staging executor 333 also causes staging system 40 generating a stimulus to at least one of the five senses of human in the facility (hotel 100) to execute staging processing based on the control content determined by the reservation information. The reservation information includes information for specifying target space 110 reserved by the user. Thus, staging executor 333 specifies target space 110 reserved by the user from the reservation information acquired by reservation information acquirer 331, and determines the control content to include the content for guiding the user to target space 110. Accordingly, the staging of guiding the user to target space 110 can be performed by staging system 40.

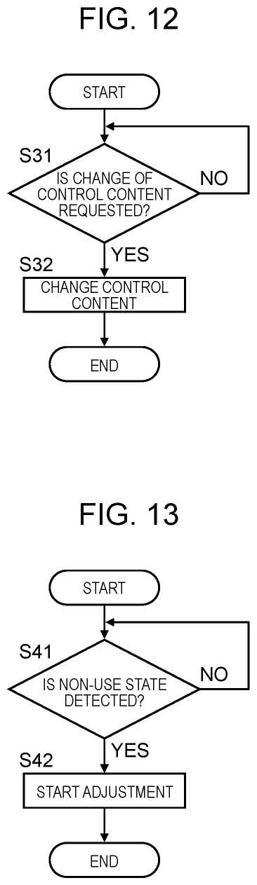

Staging change unit 334 changes the control content as described above. That is, staging change unit 334 performs a step of changing the control content (see staging change step S32 and FIG. 12). In the exemplary embodiment, as illustrated in FIG. 12, when receiving a request for changing the control content (S31), staging change unit 334 changes the control content in accordance with the received request (S32). The request to change the control content can be made by the user using first terminal device 701, for example. For example, when the staging information included in the reservation information is “nature”, the user may change the staging information from “nature” to “sports” by first terminal device 701. Thus, staging executor 333 causes staging system 40 to execute staging processing with the control content corresponding to “sports”. Therefore, the user can freely change the control content using first terminal device 701.

Non-use detector 335 detects that the specific space is in a non-use state. That is, non-use detector 335 performs a step (see non-use detection step S41 and FIG. 13) of detecting that the specific space is in the non-use state. Specifically, non-use detector 335 determines whether the specific space is in the non-use state. The non-use state is a state in which the specific space is not used by a person including at least the user. The state in which the specific space is not used by a person including at least the user can be a state in which there is no person including at least the user in the specific space. When the specific space is guest room 110A, even when there is no user in guest room 110A, a housekeeper who is a staff member of hotel 100 may be, for example, cleaning guest room 110A. Thus, the “person” mentioned here can include a staff member of hotel 100 in addition to the user. Of course, the “person” may be only the user. Detection system 50 can be used to detect that the specific space is in the non-use state. In the exemplary embodiment, control system 30 of each space staging subsystem 200 receives the detection result from detection system 50 of the plurality of space staging subsystems 200 of space staging system 20. Non-use detector 335 of control system 30 detects that the specific space is in the non-use state on the basis of the received detection result. The specific space can be any of the spaces in hotel 100 (target space 110, non-target space 120). That is, the specific space may be target space 110 reserved by the user, or may be a space other than target space 110 reserved by the user (for example, non-target space 120). In a case where the specific space is guest room 110A, it may be required to insert a card key into a card slot in guest room 110A when guest room 110A is used. In this case, it is possible to detect that the specific space is in the non-use state depending on whether the card key is inserted into the card slot.

Staging adjuster 336 causes staging system 40 to execute adjustment processing of adjusting a position where a stimulus is generated in the specific space. That is, staging adjuster 336 performs a step of causing staging system 40 to execute the adjustment processing of adjusting the position where the stimulus is generated in the specific space (see staging adjustment step S42 and FIG. 13). For example, in a case where staging device 41 is a projector, there is a possibility that a projection position of an image by the projector deviates from a specified position. Therefore, in the adjustment processing, staging system 40 adjusts a direction or the like of the projector such that the projection position of the image by the projector coincides with the specified position. In the exemplary embodiment, when non-use detector 335 detects that the specific space is in the non-use state, staging adjuster 336 causes staging system 40 to execute the adjustment processing. Accordingly, when the specific space is in the non-used state, staging system 40 can be caused to execute the adjustment processing. Therefore, staging adjuster 336 can cause staging system 40 to automatically execute the adjustment processing, and relieve time and effort required for the adjustment of staging system 40. Furthermore, since the adjustment processing is executed in a case where the specific space is in the non-used state, it is possible to reduce possibility that the adjustment processing interferes with the user or the staff member of hotel 100.

(1-3) Operation

Hereinafter, examples of the space staging method will be described with reference to FIGS. 4, 5, and 14 to 17.

### (1-3-1) FIRST EXAMPLE

FIG. 4 illustrates a first example of the space staging. In the first example, target space 110 and the specific space are the same, and both are guest room 110A. In the first example, space staging subsystem 200 corresponding to guest room 110A in space staging system 20 is used. That is, staging system 40 that generates a stimulus in target space (guest room) 110A is used. In space staging subsystem 200 corresponding to guest room 110A, the plurality of staging devices 41 of staging system 40 include displays 411, 412, 413, 414 and staging light source device 415. Displays 411, 413 are installed on wall surface 111 of guest room 110A. Display 412 is installed so as to be movable up and down on an upper part of window 112. Display 414 is a transparent display installed as a window glass of window 112. At least one of staging devices 41 is a projector that projects a video image onto wall surface 111 of guest room 110A. Door or window fixture system 44 also includes electric curtain 441 provided to window 112.

In the first example, the space staging method includes reservation information acquisition step S21, entry detection step S22, and staging execution step S23. Reservation information acquisition step S21 is a step of acquiring reservation information about the reservation of target space (guest room) 110A of facility (hotel) 100. Entry detection step S22 is a step of detecting entry of the user specified by the reservation information into specific space (guest room) 110A in hotel 100. Staging execution step S23 is a step of causing staging system 40 generating a stimulus in specific space (guest room) 110A to execute staging processing based on the control content determined by the reservation information.

In the first example, the reservation information includes the staging information on the theme of “nature”, and the control content specified by the staging information is the content that defines the space staging on the theme of “nature” in guest room 110A. For example, the control content includes content that cause display 412, 413 to output a video image representing a petal and causing display 414 to output a video image representing a waterfall. Further, the control content includes a content that closes electric curtain 441 to some extent to be used as a screen and project a video image representing a flower on wall surface 111 of guest room 110A by the projector. The control content includes a content that causes staging light source device 415 to illuminate with light representing nature. As described above, in guest room 110A, staging system 40 executes staging processing based on the control content determined by the reservation information of the user.

### (1-3-2) SECOND EXAMPLE

FIG. 5 illustrates a second example of the space staging. In the second example, target space 110 and the specific space are the same, and both are guest room 110A. In the second example, space staging subsystem 200 corresponding to guest room 110A in space staging system 20 is used.

In the second example, the space staging method includes reservation information acquisition step S21, entry detection step S22, and staging execution step S23. Reservation information acquisition step S21 is a step of acquiring reservation information about the reservation of target space (guest room) 110A of facility (hotel) 100. Entry detection step S22 is a step of detecting entry of the user specified by the reservation information into specific space (guest room) 110A in hotel 100. Staging execution step S23 is a step of causing staging system 40 generating a stimulus in specific space (guest room) 110A to execute staging processing based on the control content determined by the reservation information.

In the second example, the reservation information includes the staging information on the theme of “sports”, and the control content specified by the staging information is the content that defines the space staging on the theme of “sports” in guest room 110A. For example, the control content includes a content that causes displays 413, 414 to output a video image related to a sports game. In the second example, since display 414 is mainly used, the control content includes a content that opens electric curtain 441 and accommodates display 412. The control content includes a content that causes the projector to project a video image for making a sports game exciting on wall surface 111 of guest room 110A. The control content includes a content that causes staging light source device 415 to illuminate with light enhancing a mood. As described above, in guest room 110A, staging system 40 executes staging processing based on the control content determined by the reservation information of the user.

### (1-3-3) THIRD EXAMPLE

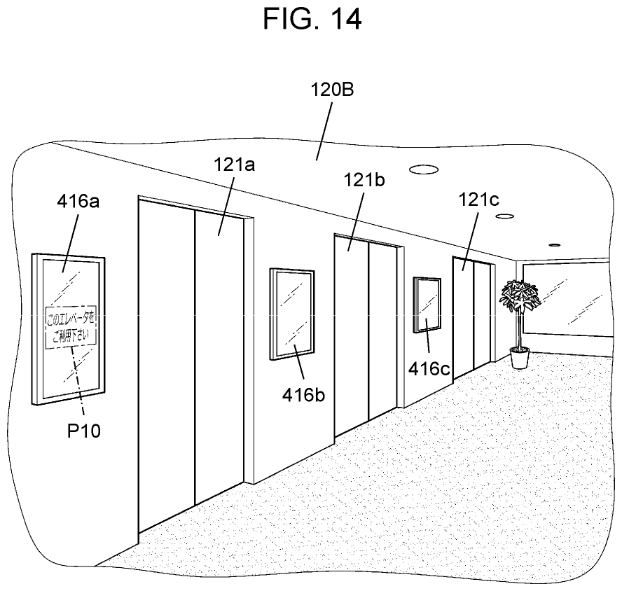

FIG. 14 illustrates a third example of the space staging. In the third example, target space 110 and the specific space are different. Target space 110 is guest room 110A. The specific space is non-target space 120, specifically, elevator hall 120B. Elevator hall 120B is a space connected to target space (guest room) 110A. That is, elevator hall 120B is in a route from front desk 120A to guest room 110A. In the third example, space staging subsystem 200 corresponding to elevator hall 120B in space staging system 20 is used. That is, staging system 40 that generates a stimulus in the specific space (elevator hall 120B) is used. In space staging subsystem 200 corresponding to elevator hall 120B, the plurality of staging devices 41 of staging system 40 include displays 416a, 416b, 416c disposed corresponding to elevator doors 121a, 121b, 121c, respectively.

In the third example, the space staging method includes reservation information acquisition step S21, entry detection step S22, and staging execution step S23. Reservation information acquisition step S21 is a step of acquiring reservation information about the reservation of target space (guest room) 110A of facility (hotel) 100. Entry detection step S22 is a step of detecting entry of the user specified by the reservation information into specific space (elevator hall) 120B in hotel 100. Staging execution step S23 is a step of causing staging system 40 generating a stimulus in specific space (elevator hall) 120B to execute staging processing based on the control content determined by the reservation information.

In the third example, the reservation information includes information about target space (guest room) 110A reserved by the user, and the control content specified by the reservation information includes a content that guides the user to guest room 110A. For example, the content that guides the user to guest room 110A includes a content that displays image P10 of guidance to the elevator used for movement to guest room 110A on display 416a next to elevator door 121a. Image P10 includes, for example, a display of “Please use this elevator”. As described above, in elevator hall 120B, staging system 40 executes staging processing based on the control content determined by the reservation information of the user.

### (1-3-4) FOURTH EXAMPLE

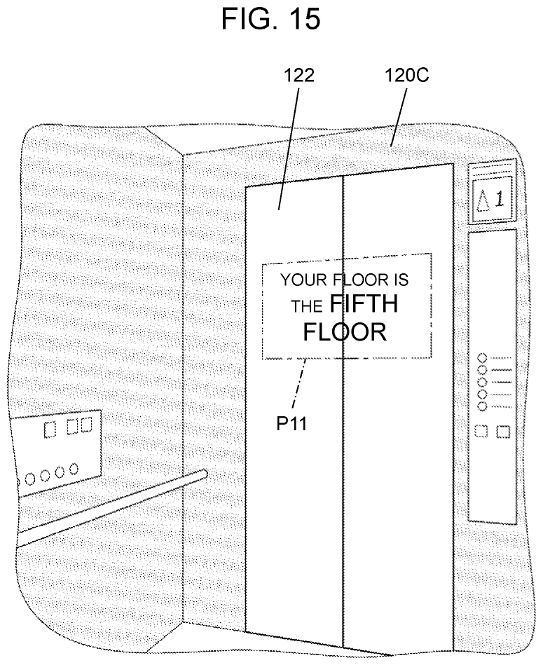

FIG. 15 illustrates a fourth example of the space staging. In the fourth example, target space 110 and the specific space are different. Target space 110 is guest room 110A. The specific space is non-target space 120, specifically, elevator 120C. Elevator 120C is a space connected to target space (guest room) 110A. That is, elevator 120C is in a route from front desk 120A to guest room 110A. In the fourth example, space staging subsystem 200 corresponding to elevator 120C in space staging system 20 is used. That is, staging system 40 that generates a stimulus in the specific space (elevator 120C) is used. In space staging subsystem 200 corresponding to elevator 120C, the plurality of staging devices 41 of staging system 40 include a projector that projects a video image on door 122 of elevator 120C.

In the fourth example, the space staging method includes reservation information acquisition step S21, entry detection step S22, and staging execution step S23. Reservation information acquisition step S21 is a step of acquiring reservation information about the reservation of target space (guest room) 110A of facility (hotel) 100. Entry detection step S22 is a step of detecting entry of the user specified by the reservation information into specific space (elevator) 120C in hotel 100. Staging execution step S23 is a step of causing staging system 40 generating a stimulus in specific space (elevator) 120C to execute staging processing based on the control content determined by the reservation information.

In the fourth example, the reservation information includes information about target space (guest room) 110A reserved by the user, and the control content specified by the reservation information includes a content that guides the user to guest room 110A. For example, the content that guides the user to guest room 110A includes the content that projects video image P11 for guiding a floor on which guest room 110A is located (a floor on which the user gets off) on door 122 of elevator 120C. Video image P11 includes, for example, a display of “Your floor is the fifth floor”. As described above, in elevator 120C, staging system 40 executes staging processing based on the control content determined by the reservation information of the user.

### (1-3-5) FIFTH EXAMPLE

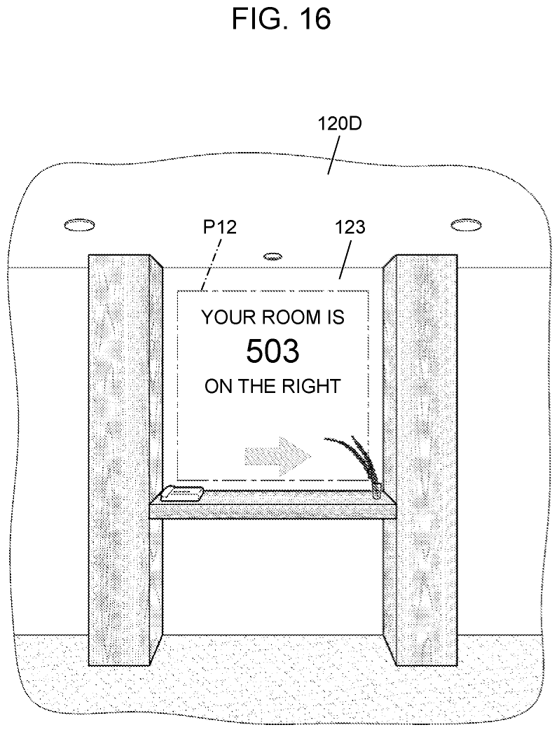

FIG. 16 illustrates a fifth example of the space staging. In the fifth example, target space 110 and the specific space are different. Target space 110 is guest room 110A. The specific space is non-target space 120, specifically, guest room passage 120D. Guest room passage 120D is a space connected to target space (guest room) 110A. That is, guest room passage 120D is in a route from front desk 120A to guest room 110A. In particular, guest room passage 120D is a part between the elevator hall on the floor on which guest room 110A is located and guest room 110A. In the fifth example, space staging subsystem 200 corresponding to guest room passage 120D in space staging system 20 is used. That is, staging system 40 that generates a stimulus in the specific space (guest room passage 120D) is used. In space staging subsystem 200 corresponding to guest room passage 120D, the plurality of staging devices 41 of staging system 40 include a projector that projects a video image on wall surface 123 of guest room passage 120D.

In the fifth example, the space staging method includes reservation information acquisition step S21, entry detection step S22, and staging execution step S23. Reservation information acquisition step S21 is a step of acquiring reservation information about the reservation of target space (guest room) 110A of facility (hotel) 100. Entry detection step S22 is a step of detecting entry of the user specified by the reservation information into specific space (guest room passage) 120D in hotel 100. Staging execution step S23 is a step of causing staging system 40 generating a stimulus in specific space (guest room passage) 120D to execute staging processing based on the control content determined by the reservation information.

In the fifth example, the reservation information includes information about target space (guest room) 110A reserved by the user, and the control content specified by the reservation information includes a content that guides the user to guest room 110A. For example, the content that guides the user to guest room 110A includes a content that projects video image P12 for guiding a direction and a number of guest room 110A on wall surface 123 of guest room passage 120D. Video image P12 includes, for example, a display of “Your room is 503 on the right”. As described above, in guest room passage 120D, staging system 40 executes staging processing based on the control content determined by the reservation information of the user.

### (1-3-6) SIXTH EXAMPLE

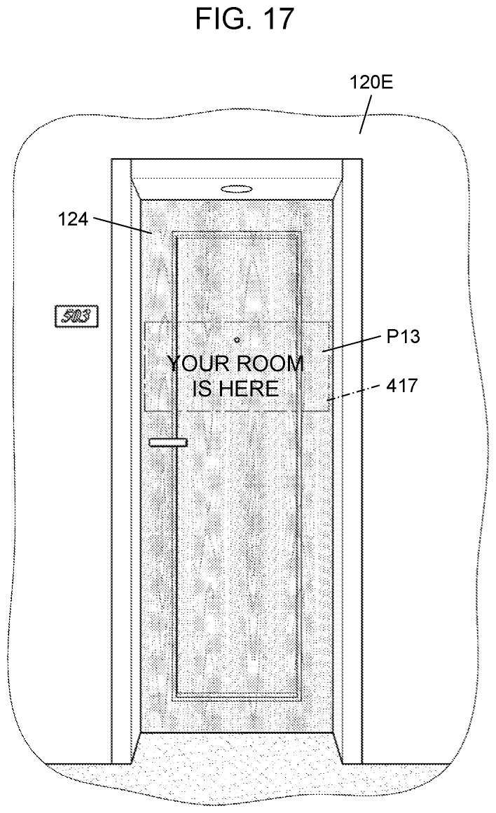

FIG. 17 illustrates a sixth example of the space staging. In the sixth example, target space 110 and the specific space are different. Target space 110 is guest room 110A. The specific space is non-target space 120, specifically, guest room passage 120E. Guest room passage 120E is a space connected to target space (guest room) 110A. That is, guest room passage 120E is in a route from front desk 120A to guest room 110A. In particular, guest room passage 120E is a part in front of guest room 110A. In the fifth example, space staging subsystem 200 corresponding to guest room passage 120E in space staging system 20 is used. That is, staging system 40 that generates a stimulus in the specific space (guest room passage 120E) is used. In space staging subsystem 200 corresponding to guest room passage 120E, the plurality of staging devices 41 of staging system 40 include display 417 built in door 124 corresponding to guest room 110A. Display 417 is apparently integrated with door 124, and the presence of display 417 cannot be recognized when no image is displayed. On the other hand, when display 417 displays an image, the image is displayed so as to appear on a surface of door 124.

Display 417 includes, for example, an image display layer (light emitting layer) that displays an image on a display surface, and a decorative layer disposed on the display surface of the image display layer. The image display layer can be a liquid crystal display with a backlight, an organic light emitting diode (OLED) display, or an LED display. The decorative layer has a front surface opposite to the image display layer and a back surface facing the image display layer. The surface of the decorative layer is formed to have an outer appearance in harmony with door 124. For example, if door 124 has a wood grain design, the surface of the decorative layer has a wood grain design. In the exemplary embodiment, the decorative layer is formed integrally with door 124. The decorative layer is configured to transmit light from the image display layer and make an image displayed on the display surface visible. For example, the decorative layer has a plurality of openings through which light from the image display layer passes. A reflection reducing layer that reduces reflection of light from the image display layer can be provided on the back surface of the decorative layer. The reflection reducing layer is formed so as not to cover the plurality of openings. The reflection reducing layer may include a material that absorbs light from the image display layer or a material having a reflectance lower than a reflectance of a facing surface of the decorative layer, or may be formed by performing a treatment for reducing reflection on a part other than the front surface (back surface, cross section, or the like) of the decorative layer. By providing the reflection reducing layer, when display 417 displays an image, blur of the image on the surface of door 124 can be reduced. Each opening of the decorative layer may have a wedge-shaped cross section that decreases in size from the back surface toward the front surface of the decorative layer. Accordingly, when display 417 displays an image, blur of the image on the surface of door 124 can be reduced. The plurality of openings may be regularly arranged or randomly arranged. When the arrangement of the plurality of openings is random, moire that can occur when display 417 displays an image can be reduced. Display 417 may include an intermediate layer between the image display layer (light emitting layer) and the decorative layer. Examples of the intermediate layer include an optical shutter layer (light shielding layer) and a condensing layer. The optical shutter layer enables switching between transmission and blocking of light by controlling application of a voltage to the optical shutter layer. For example, when the image display layer is not displaying an image, the optical shutter layer is in a state of blocking light. This makes it difficult to visually recognize display 417 from door 124, and the decorative layer can be thinned. The condensing layer is a layer for condensing light from the image display device. The condensing layer can include, for example, a lens, a light deflecting filter, or the like. Providing the condensing layer can improve linear luminance of the image display device. As a result, a display direction of the image on display 417 can be limited, and a display content of display 417 can be made difficult to be visually recognized by others around door 124.

In the sixth example, the space staging method includes reservation information acquisition step S21, entry detection step S22, and staging execution step S23. Reservation information acquisition step S21 is a step of acquiring reservation information about the reservation of target space (guest room) 110A of facility (hotel) 100. Entry detection step S22 is a step of detecting entry of the user specified by the reservation information into specific space (guest room passage) 120E in hotel 100. Staging execution step S23 is a step of causing staging system 40 generating a stimulus in specific space (guest room passage) 120E to execute staging processing based on the control content determined by the reservation information.

In the sixth example, the reservation information includes information about target space (guest room) 110A reserved by the user, and the control content specified by the reservation information includes a content that guides the user to guest room 110A. For example, the content that guides the user to guest room 110A includes the content that displays video image P13 for guiding a location of guest room 110A on display 417 on the surface of door 124 of guest room 110A. Video image P13 includes, for example, a display of “Your room is here”. As described above, in guest room passage 120E, staging system 40 executes staging processing based on the control content determined by the reservation information of the user.

In the sixth example, after the entry of the user into guest room passage 120E is detected, the staging processing may be ended after a certain period since the user is not detected. The space staging method may include a step of acquiring information indicating that the user detected in entry detection step S22 matches the user specified by the reservation information acquired in reservation information acquisition step S21. The space staging method may include a step of changing the display content of display 417 or a display position of the image on display 417 in accordance with the acquired information for specifying the user.

When display 417 detects entry of the staff member of hotel 100 to guest room passage 120E, display 417 may display information different from the information displayed to the user. For example, display 417 may display information such as a situation and attribute of the user staying in guest room 110A in response to the entry of the staff member.

Display 417 may be provided not only on one side but also on both sides of door 124. In a case where display 417 is provided on a side of guest room 110A (interior side) of door 124, when the user is present in guest room 110A, an image may be constantly displayed on display 417. When a visitor of guest room 110A is detected while the user is in guest room 110A, a captured video image of guest room passage 120E may be displayed on display 417 on the side of guest room 110A. The information input by the user may be displayed on display 417 on the side of guest room passage 120E (exterior side).

In the space staging method, schedule information is acquired from terminal device 70 of the user through communication network 90 when the user leaves guest room 110A, and a schedule and information about the schedule may be displayed on the basis of the acquired schedule information.

In this sixth modification, illumination system 42 around door 124 may be controlled in accordance with display or non-display of an image on display 417. As a result, illuminance (environmental illuminance) around door 124 can be adjusted so as to enhance visibility of the image displayed on display 417.

In the sixth modification, a projector may be used instead of display 417. That is, the display of the video image on door 124 can also be implemented by projection mapping using a projector.

(1-4) Conclusion

As described above, space staging system 20 includes reservation information acquirer 331 and staging executor 333. Reservation information acquirer 331 acquires the reservation information about the reservation of target space 110 of facility (hotel) 100. Upon detection of entry of the user specified by the reservation information into the specific space in facility 100, staging executor 333 causes staging system 40 generating a stimulus to at least one of the five senses of human in facility (hotel) 100 to execute staging processing based on the control content determined by the reservation information. Space staging system 20 as described above allows space staging suitable for the user to be executed at an appropriate timing in facility 100.

In other words, it can be said that space staging system 20 executes the method (space staging method) as illustrated in FIG. 6. The space staging method includes reservation information acquisition step S21, entry detection step S22, and staging execution step S23. Reservation information acquisition step S21 is a step of acquiring reservation information about the reservation of target space 110 of facility (hotel) 100. Entry detection step S22 is a step of detecting entry of the user specified by the reservation information into the specific space in facility 100. Staging execution step S23 is a step of causing staging system 40 generating a stimulus to at least one of the five senses of human in facility 100 to execute staging processing based on the control content determined by the reservation information. The space staging method as described above allows space staging suitable for the user to be executed at an appropriate timing in facility 100, similarly to space staging system 20.

Space staging system 20 is implemented using a computer system. That is, the method (space staging method) executed by space staging system 20 can be implemented by the computer system executing a program. This program is a computer program that causes at least one processor to execute the space staging method. Such a program allows space staging suitable for the user to be executed at an appropriate timing in facility 100, similarly to space staging system 20.

As described above, space staging system 20 includes non-use detector 335 and staging adjuster 336. Non-use detector 335 determines whether the specific space is in the non-use state. When non-use detector 335 detects that the specific space is in the non-use state, staging adjuster 336 causes staging system 40 generating a stimulus to at least one of the five senses of human in the specific space to execute the adjustment processing of adjusting the position where the stimulus is generated. Space staging system 20 can cause staging system 40 to automatically execute the adjustment processing, and relieve time and effort required for the adjustment of staging system 40. Furthermore, it is possible to reduce the possibility that the adjustment processing interferes with a person.

In other words, it can be said that space staging system 20 executes the method (space staging method) as illustrated in FIG. 6. The space staging method further includes non-use detection step S41 and staging adjustment step S42. Non-use detection step S41 is a step of detecting that the specific space is in the non-use state. Staging adjustment step S42 is a step of causing staging system 40 generating a stimulus to at least one of the five senses of human in the specific space to execute the adjustment processing of adjusting the position where the stimulus is generated. This space staging method can cause staging system 40 to automatically execute the adjustment processing, and relieve time and effort required for the adjustment of staging system 40, similarly to space staging system 20. Furthermore, it is possible to reduce the possibility that the adjustment processing interferes with a person.

Space staging system 20 is implemented using a computer system. That is, the method (space staging method) executed by space staging system 20 can be implemented by the computer system executing a program. This program is a computer program that causes at least one processor to execute the space staging method. Such a program can cause staging system 40 to automatically execute the adjustment processing, and relieve time and effort required for the adjustment of staging system 40, similarly to space staging system 20. Furthermore, it is possible to reduce the possibility that the adjustment processing interferes with a person.

(2-1) First Modification

The exemplary embodiment of the present disclosure is not limited to the above exemplary embodiment. The above exemplary embodiment can be variously modified depending on design and the like as long as the object of the present disclosure can be achieved. Modifications of the above exemplary embodiment will be listed below. The modifications described below can be applied in appropriate combination.

In the exemplary embodiment, it has been described that the space staging method is executed while the user is staying at hotel 100 (S15) and when the user is guided to guest room 110A (S13), but the space staging method may be executed for services provided by hotel 100 to the user at an appropriate time. For example, the space staging method can be used for guiding the user from guest room 110A to front desk 120A (S17). The space staging method can also be used when the user enters or leaves guest room 110A. At entry, it is possible to provide space staging that welcomes the user, and at exit, it is possible to provide space staging that sends off the user.

In one modification, target space 110 is not limited to guest room 110A, and may be conference room 110B, restaurant 110C, or recreational room 110D. Conference room 110B makes it possible to cause staging system 40 corresponding to conference room 110B to execute staging processing based on the control content determined by the reservation information. Accordingly, it is possible to cause staging system 40 to execute staging processing according to a content of a conference in conference room 110B. Restaurant 110C makes it possible to cause staging system 40 corresponding to restaurant 110C to execute staging processing based on the control content determined by the reservation information. Thus, in restaurant 110C, it is possible to cause staging system 40 to execute staging processing according to a content of a party (wedding reception, celebration, or the like) held in restaurant 110C. Recreational room 110D makes it possible to cause staging system 40 corresponding to recreational room 110D to execute staging processing based on the control content determined by the reservation information. Accordingly, in recreational room 110D, it is possible to cause staging system 40 to execute staging processing according to an activity (spa, beauty treatment, fitness, or the like) in recreational room 110D. In the space staging method, it is also possible to perform space staging that guides the user to conference room 110B, restaurant 110C, or recreational room 110D.

In one modification, the specific space may be any one of a plurality of spaces of target space 110. For example, in a case where the specific space is guest room 110A, the specific space may be a living room or a bedroom of guest room 110A. In the case where the specific space is restaurant 110C, the specific space may be a private room or a table in restaurant 110C.

In one modification, the reservation information may include attribute information of the user. In this case, the control content may be determined by using the attribute information included in the reservation information. For example, staging executor 333 may extract attribute information from the reservation information acquired by reservation information acquirer 331, and specify the control content on the basis of the attribute information. In this case, the user does not need to input staging information. The attribute information of the user can include information about appearance of the user (face image), information about an age (date of birth or the like), information about a gender, information about a family (family structure or the like), information about a hobby, information about a preference (information about likes and dislikes or the like), information about an anniversary, information about a purpose of use (purpose of visit or stay or the like), information about work, information about an address or residence, information about a number of users, and the like. For example, staging executor 333 may specify the control content by an age group and gender of the user. Staging executor 333 may specify the control content such that the space staging for congratulating an anniversary of the user is executed on the anniversary. It is therefore possible to perform space staging that congratulates a birthday on the birthday of the user. Staging executor 333 may specify the control content by the information about preference. It is therefore possible to avoid space staging that is not suitable to the preference of the user. Staging executor 333 may specify the control content by the information about the family. It is therefore possible to switch between space staging for children and space staging for adults in accordance with a time zone.

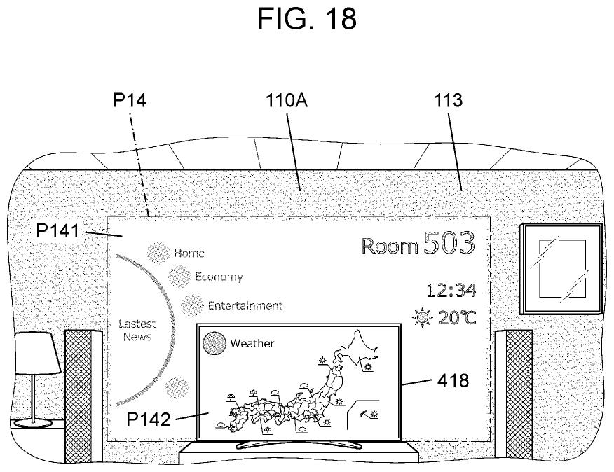

FIG. 18 illustrates an example of the space staging. In this modification, target space 110 and the specific space are the same, and both are guest room 110A. Space staging subsystem 200 corresponding to guest room 110A in space staging system 20 is used. That is, staging system 40 that generates a stimulus in target space (guest room) 110A is used. In space staging subsystem 200 corresponding to guest room 110A, the plurality of staging devices 41 of staging system 40 include display 418. Display 418 is installed on wall surface 113 of guest room 110A. At least one of the plurality of staging devices 41 is a projector that projects a video image onto wall surface 113 of guest room 110A. As described above, staging system 40 includes a plurality of visual staging devices (display 418, projector) of different types. Staging system 40 can display a video image as a whole by displaying different parts of the video image represented by a video signal by the plurality of visual staging devices. Here, video image P14 is divided into first part P141 projected by the projector and second part P142 displayed on display 418. First part P141 and second part P142 do not overlap each other, and constitute one video image P14.

In the modification, the space staging method includes reservation information acquisition step S21, entry detection step S22, and staging execution step S23. Reservation information acquisition step S21 is a step of acquiring reservation information about the reservation of target space (guest room) 110A of facility (hotel) 100. Entry detection step S22 is a step of detecting entry of the user specified by the reservation information into specific space (guest room) 110A in hotel 100. Staging execution step S23 is a step of causing staging system 40 generating a stimulus in specific space (guest room) 110A to execute staging processing based on the control content determined by the reservation information.

In the modification, the reservation information includes the attribute information of the user, and the control content specified by the attribute information is the content that defines the space staging on the theme of “leisure” in guest room 110A. For example, the control content includes a content of displaying video image P14 about leisure by display 418 and the projector. As described above, in guest room 110A, staging system 40 executes staging processing based on the control content determined by the reservation information of the user.

In one modification, the space staging method may include a video image content desired by the user (pictures and moving images in terminal device 70, a screen of an application such as a game or a social network service (SNS) executed by terminal device 70, and the like) in the space staging. For example, in the example illustrated in FIG. 4, control system 30 may display the video image content provided (imported) from terminal device 70 of the user on display 412 as a part of the space staging. For example, in the example illustrated in FIG. 18, control system 30 may display the video image content provided (imported) from terminal device 70 of the user on display 418 as a part of the space staging. It is therefore possible to display the video image content desired by the user by a picture-in-picture (PinP) technique.

In one modification, the reservation information may include identification information of the user. In this case, the control content may be determined by using the identification information included in the reservation information. For example, staging executor 333 may extract identification information from the reservation information acquired by reservation information acquirer 331, and specify the control content on the basis of the identification information. In this case, the user does not need to input staging information. The identification information of the user can be associated with, for example, customer information. Thus, information about past use of hotel 100 by the user can be acquired from customer management database 621 on the basis of the identification information. For example, staging executor 333 may specify the control content on the basis of data of past stay of the user in hotel 100. In a case where the user uses hotel 100 for the first time and the identification information of the reservation information of the user is not associated with the customer information, a control content corresponding to predetermined space staging for the first use of hotel 100 can be selected.

In one modification, staging change unit 334 (staging change step S32) may change the control content in accordance with a position of the user in the specific space. For example, in a case where the specific space is guest room 110A, the control content can be made different depending on whether the user is in the living room or in the bedroom. For example, it is possible to perform space staging that gives an active mood to the user in the living room, and to perform space staging that gives a relaxing mood to the user in the bedroom. For example, in a case where the specific space is restaurant 110C, the control content can be made different depending on whether the user is at an entrance or at an exit. For example, space staging that welcomes the user may be performed at the entrance, and space staging that sends off the user may be performed at the exit.

In one modification, display 417 may be installed in a lobby of hotel 100. In this case, display 417 may be provided on an object such as a wall of the lobby instead of door 124. Display 417 may change the display content in accordance with information of whether the user has checked in, information of whether the user has checked out, or both of the information. Display 417 may display guidance indicating evacuation as a guide light in accordance with weather information or disaster information in an area where hotel 100 is located, or emergency information in hotel 100.

In one modification, display 417 may be installed at the front desk of hotel 100. In this case, display 417 may display guidance of check-in or guidance of check-out in accordance with the information indicating a check-in status or the information indicating a check-out status of the user. Display 417 may change a position of display of the guidance in a display area of display 417 in accordance with the position of the user with respect to display 417.

In one modification, display 417 may be installed on a wall in guest room 110A. In this case, the surface of the decorative layer of display 417 may be configured by using the same material as a wall material or a wall paper. When the user is in guest room 110A, display 417 may constantly display or periodically display an image regardless of the position of the detected user. This allows the user to recognize the position of display 417. Display 417 may start displaying an image or change the display content in accordance with a voice uttered by the user. Display 417 can change a display state, specifically, on and off of display and luminance in conjunction with the illumination of guest room 110A. Display 417 may change the display state in accordance with the information acquired through communication network 90.

The position where display 417 is installed in hotel 100 is not limited to the location and position described above, and may be installed on an object such as a wall, a ceiling, a table, or a shelf of an elevator, a corridor, a restaurant, a casino, a conference room, or an exhibition hall. That is, display 417 only has to be hidden by the decorative layer so as not to be distinguished from other objects on which display 417 is installed in a non-display state in which no image is displayed, and the position of installation is not limited to the above.

Space staging system 20 performing the space staging method according to the exemplary embodiment is not limited to the example illustrated in FIG. 7. Space staging system 20 does not necessarily include the plurality of space staging subsystems 200. Each space staging subsystem 200 is not necessarily divided into control system 30, staging system 40, and detection system 50. Thus, space staging system 20 only has to include at least reservation information acquirer 331 and staging executor 333.

Space staging system 20 of the present disclosure includes, for example, a computer system. The computer system mainly includes a processor and a memory as hardware. The processor executes a program recorded in the memory of the computer system to implement a function as space staging system 20 in the present disclosure. The program may be recorded in advance in the memory of the computer system, may be provided through a telecommunication line, or may be provided by being recorded in a non-transitory recording medium readable by the computer system, such as a memory card, an optical disk, or a hard disk drive. The processor of the computer system includes one or a plurality of electronic circuits including a semiconductor integrated circuit (IC) or a large-scale integration (LSI). The integrated circuit such as the IC or the LSI in this disclosure is called differently depending on a degree of integration, and includes an integrated circuit called a system LSI, a very large scale integration (VLSI), or an ultra large scale integration (ULSI). Furthermore, a field-programmable gate array (FPGA) programmed after manufacture of LSI, and a logical device capable of reconfiguring a joint relationship in LSI or reconfiguring circuit partitions in LSI can also be used as processors. The plurality of electronic circuits may be integrated into one chip or may be provided in a distributed manner on a plurality of chips. The plurality of chips may be aggregated in one device or may be provided in a distributed manner in a plurality of devices. The computer system in this disclosure includes a microcontroller having at least one processor and at least one memory. Therefore, the microcontroller also includes one or a plurality of electronic circuits including a semiconductor integrated circuit or a large-scale integrated circuit.

It is not an essential configuration for space staging system 20 that a plurality of functions in space staging system 20 are aggregated in one housing, and the components of space staging system 20 may be provided in a distributed manner in a plurality of housings. At least some of the functions of space staging system 20, for example, some functions of processor 23 of control system 30 may be implemented by a cloud (cloud computing) or the like.

(2-2) Second Modification

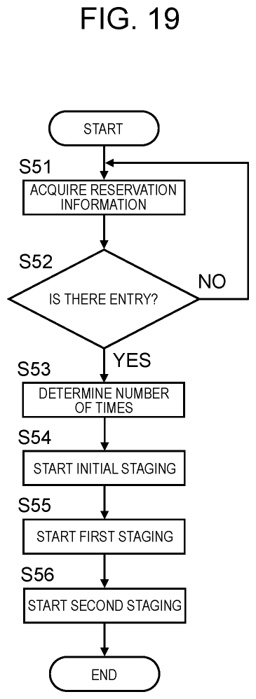

Another modification of the exemplary embodiment of the present disclosure will be described below with reference to a flowchart in FIG. 19.

The space staging method according to this modification includes reservation information acquisition step S51 and entry detection step S52, as illustrated in FIG. 6. Thereafter, upon detection of entry of the user into the specific space (guest room) in entry detection step S52 (YES in S52), a number of times of entry of the user into the specific space is determined (determination step S53). Specifically, when sensor 51 (see FIG. 7) of detection system 50 detects the user, control system 30 can determine the number of times the user having entered the specific space by receiving information indicating the detection from sensor 51 and storing the information. When entry of the user into the specific space is not detected in entry step S52 (NO in S52), the processing returns to reservation information acquisition step S51.

Here, the number of times the user having entered the specific space can be determined without using sensor 51. For example, in facility operation system 10 (see FIG. 7), a system capable of electronically unlocking a door of the guest room by using a smartphone owned by a user can be applied. In this case, facility operation system 10 can determine the number of times the user having entered the specific space (guest room) by counting the number of times the door of the guest room having been unlocked by the smartphone of the user. Short range wireless communication such as Bluetooth (registered trademark) can be used to unlock the door of the guest room by using a smartphone.

Furthermore, the number of times the user having entered the guest room may be counted by a sensor detecting that the user has set a key of the guest room at a predetermined place without using wireless communication.

For another example of electronically unlocking a door of a guest room, a technique of recognizing a user's face can also be utilized. A camera installed on the door of the guest room acquires an image of the user's face, and compares the acquired image with an image of the user's face recorded in advance at the time of reservation. When it is determined that the two images match as a result of the comparison, the door of the guest room can be unlocked. By counting the number of times the door having been unlocked in this manner, the number of times the user having entered the specific space (guest room) can also be determined. The number of times of entry after check-in can be managed by being stored in storage 62 of the management system in FIG. 9.

After determination step S53, the processing proceeds to initial staging execution step S54. In initial staging execution step S54, illumination system 42, air conditioning system 43, or door or window fixture system 44 (see FIG. 10) of staging system 40 executes staging processing. For example, as described above, upon detection that the user has entered the guest room, illumination system 42 may turn on the illumination tool in the guest room. Air conditioning system 43 may regulate temperature of the guest room. Door or window fixture system 44 may activate the electric curtains to adjust the brightness of the guest room.

The above initial staging processing may be processing based on the attribute information (control content) of the user determined by the reservation information acquired by reservation information acquirer 331. For example, illumination system 42 may adjust the brightness and color of the illumination tool in accordance with the age group and gender of the user included in the attribute information of the user. It is therefore possible to execute initial staging according to the preference of the user and execute the initial staging according to the attribute of the user before staging using the visual staging device (projector or display) to be described later. The brightness of the guest room can be adjusted for the staging by the visual staging device to be described later. Initial staging execution step S54 may be performed before determination step S53. In customer management DB621 of storage 62 of management system 60 in FIG. 9, preference of illumination adjustment setting and temperature setting during the stay or the previous stay of the user may be recorded. As a result, the information acquired by reservation information acquirer 331 from server management system 60 is information indicating the preference of the user, and the staging of the guest room according to the preference of the user can be performed.

Next, first staging processing is started (step S55). In the first staging processing, staging processing based on the number of times determined in determination step S53 is performed. Specifically, the staging processing is executed by using the visual staging device (staging device 41) of staging system 40. Here, the visual staging device is, for example, a display or a projector. The visual staging device may display an image for welcoming the user only when the number of times is the first time. The visual staging device may display a text “Welcome” when the number of times is the first time, and may display a text “Please come back” when the number of times is the second time or later. In this way, by executing the staging according to the number of times, it is possible to provide the user with appropriate staging processing. It is also possible to stop unnecessary display for the user for the second time or later. That is, the control content can be made different between when the number of times of entry is one and when the number of times of entry is two or more. For example, staging change unit 334 can count the number of times of entry from the detection result of detection system 50, and record the number of times of entry in customer management database 621 of management system 60.

Here, the display of the first staging processing may also be determined on the basis of the control content determined by the reservation information. For example, an image for welcoming the user may be determined from among a plurality of content images stored in content storage device 80 (see FIG. 7) in accordance with the attribute information of the user. A font or the like of the text to be displayed may be changed in accordance with the attribute information of the user.

Next, second staging processing is started (step S56). Since the second staging processing is similar to staging execution step S23 in FIG. 7, the details thereof will be omitted. Here, the second staging processing may be executed before or after the first staging processing, or may be executed simultaneously with the first staging processing. For example, when the second staging processing is displaying a video image by the projector, a text according to the number of times of entry of the user (first staging processing) may be superimposed on an image according to the attribute information of the user (second staging processing), and the image and the text may be simultaneously displayed. It is therefore possible to simultaneously perform display for welcoming the user. Here, the image and the text may be displayed in an overlapping manner or may be separately displayed.

In one modification, the control content may be changed in accordance with current time, month, date, or season in either the first staging processing or the second staging processing, or in both staging. For example, it is possible to make control contents different between in the morning and at night. For example, in the morning, it is possible to perform space staging including a content that notifies of a daily schedule or the like. For example, at night, it is possible to perform space staging including a content that notifies of a tomorrow's schedule or the like. For example, as for month, date, or season, it is possible to perform staging using a content of Christmas colors in Christmas season, and perform staging using a content evoking sea or fine blue sky in summer.

(3) Aspects

A first aspect is a space staging method including reservation information acquisition step (S21), entry detection step (S22), and staging execution step (S23). Reservation information acquisition step (S21) is a step of acquiring reservation information about a reservation of target space (110) of facility (100). Entry detection step (S22) is a step of detecting entry of a user specified by the reservation information into a specific space in facility (100). Staging execution step (S23) is a step of causing staging system (40) generating a stimulus to at least one of the five senses of human in facility (100) to execute staging processing based on a control content determined by the reservation information. This aspect allows space staging suitable for the user to be executed at an appropriate timing in facility (100).

A second aspect is the space staging method based on the first aspect. In the second aspect, in reservation information acquisition step (S21), the reservation information is acquired after completion of a procedure of using target space (110) in facility (100) by the user specified by the reservation information. In this aspect, the control content determined by the reservation information can be changed until completion of the procedure of using target space (110) in facility (100) of the user.

A third aspect is the space staging method based on the first or second aspect. In the third aspect, the reservation information includes staging information for specifying the control content. The control content is determined by using the staging information included in the reservation information. This aspect allows space staging to be selected at time of reservation.

A fourth aspect is the space staging method based on any one of the first to third aspects. In the fourth aspect, the reservation information includes attribute information of the user. The control content may be determined by using the attribute information included in the reservation information. This aspect enables staging processing based on the attribute information of the user.

A fifth aspect is the space staging method based on any one of the first to fourth aspects. In the fifth aspect, the reservation information includes the identification information of the user. The control content is determined by using the identification information included in the reservation information. This aspect enables staging processing based on the identification information of the user.

A sixth aspect is the space staging method based on any one of the first to fifth aspects. In the sixth aspect, the specific space is target space (110). Staging system (40) generates the stimulus in target space (110). This aspect allows space staging to be provided to the user when the user enters target space (110) having been reserved.

A seventh aspect is the space staging method based on any one of the first to sixth aspects. In the seventh aspect, the specific space is a space connected to target space (110) (120A to 120E). Staging system (40) generates the stimulus in specific space (120A to 120E). The control content includes a content that guides the user to target space (110). This aspect makes it possible to provide space staging that guides the user to target space (110) reserved by the user.

An eighth aspect is the space staging method based on any one of the first to seventh aspects. In the eighth aspect, the control content is selected from a plurality of control contents prepared in advance. This aspect facilitates setting of the control content.

A ninth aspect is the space staging method based on any one of the first to eighth aspects. In the ninth aspect, the space staging method further includes staging change step (S32) of changing the control content. In staging execution step (S23), staging system (40) is caused to execute staging processing based on the control content changed in staging change step (S32). This aspect facilitates change of the control content.

A tenth aspect is the space staging method based on the ninth aspect. In the tenth aspect, in staging change step (S32), the control content is changed in accordance with a position of the user in the specific space.

An eleventh aspect is the space staging method based on the ninth aspect. In the eleventh aspect, in staging change step (S32), the control content is changed in accordance with a number of times of entry of the user into the specific space.

A twelfth aspect is the space staging method based on any one of the first to eleventh aspects. In the twelfth aspect, staging system (40) includes staging device (41 to 43) that generates a stimulus to at least one of visual sense or auditory sense. This aspect enables space staging related to at least one of visual sense or auditory sense.

A thirteenth aspect is the space staging method based on the twelfth aspect. In the thirteenth aspect, the staging device includes visual staging device (41, 42) that performs staging using light. This aspect enables space staging using light.

A fourteenth aspect is the space staging method based on the thirteenth aspect. In the fourteenth aspect, staging system (40) includes a plurality of visual staging devices (41, 42) of different types. This aspect enables more complex space staging.

A fifteenth aspect is the space staging method based on the fourteenth aspect. In the fifteenth aspect, staging system (40) displays a video image as a whole by displaying different parts of the video image represented by a video signal by the plurality of visual staging devices (41, 42). This aspect enables more complex space staging.

A sixteenth aspect is the space staging method based on any one of the first to fifteenth aspects. In the sixteenth aspect, the space staging method further includes non-use detection step (S41) and staging adjustment step (S42). Non-use detection step (S41) is a step of detecting that the specific space is in a non-use state in which the specific space is not used by a person including at least the user. Staging adjustment step (S42) is a step of causing staging system (40) to execute adjustment processing of adjusting a position where the stimulus is generated in the specific space. This aspect can cause staging system (40) to automatically execute the adjustment processing, and can relieve time and effort required for adjustment of staging system (40). Furthermore, it is possible to reduce the possibility that the adjustment processing interferes with a person.

A seventeenth aspect is a program that causes at least one processor to execute the space staging method according to any one of the first to sixteenth aspects. This aspect allows space staging suitable for the user to be executed at an appropriate timing in facility (100).

An eighteenth aspect is space staging system (20) including reservation information acquirer (331) and staging executor (333). Reservation information acquirer (331) acquires the reservation information about the reservation of target space (110) of facility (100). Upon detection of entry of the user specified by the reservation information into the specific space in facility (100), staging executor (333) causes staging system (40) to execute staging processing based on the control content determined by the reservation information. Staging system (40) generates a stimulus to at least one of the five senses of human in facility (100). This aspect allows space staging suitable for the user to be executed at an appropriate timing in facility (100).

A nineteenth aspect is the space staging method further including non-use detection step (S41) and staging adjustment step (S42). Non-use detection step (S41) is a step of detecting that the specific space is in the non-use state in which the specific space is not used by a person including at least the user. Staging adjustment step (S42) is a step of causing staging system (40) generating a stimulus to at least one of the five senses of human in the specific space to execute the adjustment processing of adjusting the position where the stimulus is generated. This aspect can cause staging system (40) to automatically execute the adjustment processing, and can relieve time and effort required for adjustment of staging system (40). Furthermore, it is possible to reduce the possibility that the adjustment processing interferes with a person.

A twentieth aspect is a program that causes at least one processor to execute the space staging method according to the nineteenth aspect. This aspect can cause staging system (40) to automatically execute the adjustment processing, and can relieve time and effort required for adjustment of staging system (40). Furthermore, it is possible to reduce the possibility that the adjustment processing interferes with a person.

A twenty-first aspect is space staging system (20) including non-use detector (335) and staging adjuster (336). Non-use detector (335) determines whether the specific space is in the non-use state. When non-use detector (335) detects that the specific space is in the non-use state, staging adjuster (336) causes staging system (40) generating a stimulus to at least one of the five senses of human in the specific space to execute the adjustment processing in the specific space. The adjustment processing is processing of adjusting the position where the stimulus is generated. This aspect can cause staging system (40) to automatically execute the adjustment processing, and can relieve time and effort required for adjustment of staging system (40). Furthermore, it is possible to reduce the possibility that the adjustment processing interferes with a person.

Note that the second to sixteenth aspects can also be appropriately modified and applied to the seventeenth and eighteenth aspects.

### REFERENCE MARKS IN THE DRAWINGS

20 space staging system

331 reservation information acquirer

333 staging executor

40 staging system

41 staging device (visual staging device)

42 illumination system (staging device, visual staging device)

43 air conditioning system (staging device)

100 facility

110 target space

120A to 120E non-target space (space connected to target space)

S21 reservation information acquisition step

S22 entry detection step

S23 staging execution step

S32 staging change step

S41 non-use detection step

S42 staging adjustment step

1. A space staging method comprising:
acquiring reservation information about a reservation of a target space of a facility from a server;
detecting whether a user specified by the reservation information has entered a specific space in the facility;
determining a number of times of entry of the user into the specific space upon detection of entry of the user into the specific space in the detecting; and
causing a staging system that generates a stimulus to at least one of five senses of human in the facility to execute staging processing, wherein the staging processing includes:
first staging processing based on the number of times determined in the determining, and
second staging processing based on a control content determined by the reservation information.

2. The space staging method according to claim 1, wherein in the acquiring, the reservation information is acquired after completion of a procedure of using the target space in the facility by the user specified by the reservation information.

3. The space staging method according to claim 1, wherein
the reservation information includes staging information that specifies the control content, and
the control content is determined by using the staging information included in the reservation information.

4. The space staging method according to claim 1, wherein
the reservation information includes attribute information of the user, and
the control content is determined by using the attribute information included in the reservation information.

5. The space staging method according to claim 1, wherein
the reservation information includes identification information of the user, and
the control content is determined by using the identification information included in the reservation information.

6. The space staging method according to claim 1, wherein
the specific space is the target space, and
the staging system generates the stimulus in the target space.

7. The space staging method according to claim 1, wherein
the specific space is a space connected to the target space,
the staging system generates the stimulus in the specific space, and
the control content includes a content that guides the user to the target space.

8. The space staging method according to claim 1, wherein the control content is selected from a plurality of control contents prepared in advance.

9. The space staging method according to claim 1, further comprising changing the control content, wherein the causing includes causing the staging system to execute staging processing based on the control content changed in the changing.

10. The space staging method according to claim 9, wherein in the changing, the control content is changed in accordance with a position of the user in the specific space.

11. The space staging method according to claim 9, wherein in the changing, the control content is changed in accordance with the number of times determined in the determining.

12. The space staging method according to claim 1, wherein the staging system includes a staging device that generates a stimulus to at least one of visual sense or auditory sense.

13. The space staging method according to claim 12, wherein the staging device includes a visual staging device that performs staging using light.

14. The space staging method according to claim 13, wherein the first staging processing includes displaying, by using the visual staging device, a text based on the number of times determined in the determining.

15. The space staging method according to claim 14, wherein the second staging processing includes displaying, by using the visual staging device, an image based on the control content.

16. The space staging method according to claim 15, wherein the text and the image are simultaneously displayed in the causing.

17. The space staging method according to claim 13, wherein
the staging system includes a device other than the visual staging device, and
the space staging method further comprises causing the device other than the visual staging device to execute initial staging processing after the detecting and before the causing.

18. The space staging method according to claim 17, wherein the initial staging processing is processing based on the control content determined by the reservation information.

19. The space staging method according to claim 13, wherein the staging system includes a plurality of the visual staging devices of different types.

20. The space staging method according to claim 19, wherein the staging system displays a whole video image by displaying different parts of the whole video image represented by a video signal by using the plurality of visual staging devices.

21. The space staging method according to claim 1, further comprising:
detecting that the specific space is in a non-use state in which the specific space is not used by a person including at least the user; and
causing the staging system to execute adjustment processing of adjusting a position at which the stimulus is generated in the specific space.

22. A non-transitory computer readable medium storing a program that causes at least one processor to execute the space staging method according to claim 1.

23. A space staging system comprising:
a reservation information acquirer that acquires reservation information about a reservation of a target space of a facility from a server; and
a staging executor that causes a staging system that generates a stimulus to at least one of five senses of human in the facility to execute staging processing upon detection that a user specified by the reservation information has entered a specific space in the facility, wherein the staging processing includes:
first staging processing based on a number of times of entry of the user into the specific space, and
second staging processing based on a control content determined by the reservation information.
